(19) United States
(12) Patent Application Publication
(10) Pub. No.: US 2026/0342888 A1
(43) Pub. Date: Oct. 29, 2026

(54) System and method to dynamically route communications using weighted prioritization tags

(71) Applicant: Bank of America Corporation, Charlotte, NC (US)

(72) Inventors: Shyam Acharya, Monroe Township, NJ (US); Chandra Vijayan Ramasamy, Concord, NC (US); Arpit Tulsyan, Delhi (IN); Saurabh Gupta, Dwarka (IN); Sampath Kumar Sathiyamoorthy, Chennai (IN); Mauli Saluram Kharat, Jalna (IN); Subburathinam Krishnan, Chennai (IN); Sandeep Gandhi, Waxhaw, NC (US); Nimisha Madhani, Kendall Park, NJ (US)

(21) Appl. No.: 19/191,647

(22) Filed: Apr. 28, 2025

(51) Int. Cl. H04L 67/63

(52) U.S. Cl. CPC H04L 67/63

(57) ABSTRACT

An apparatus comprises a memory communicatively coupled to a processor. The processor is configured to intercept a data stream exchanged between a user device and a workspace device, electronically extract a current topic associated with a current data exchange operation, assign a weighted prioritization tag associated with a previous topic to the current topic, electronically extract an insight from the current data exchange operation, and modify a value of the weighted prioritization tag assigned to the current topic based at least in part upon the insight. Further, the processor is configured to generate an explanation file reporting an insight type associated with the insight and an impact of the insight type in the value of the weighted prioritization tag and queue a communication packet for interaction with the workspace device at a queue position.

### TECHNICAL FIELD

The present disclosure relates generally to routing operations, and more specifically to a system and method to dynamically route communications using weighted prioritization tags.

### BACKGROUND

In communication systems, multiple devices may perform communication operations with one another. In certain communication systems, the communication operations may be data exchanges performed between two or more devices. The communication operations may consume (e.g., use) network resources each time data is exchanged. The network resources may comprise power resources, memory resources, and/or processing resources. Several network resources may be consumed in processes comprising lengthier communication operations lasting multiple minutes. Further, several resources may be consumed in processes comprising larger data exchanges in which multiple information packets are exchanged.

### SUMMARY OF THE DISCLOSURE

one or more embodiments, a system and method described herein are configured to dynamically route communications using weighted prioritization tags. In particular, the system may be configured to integrate a Shapely Additive Explanation (SHAP)-powered sentiment analysis and interpretation system with Variational Autoencoders (VAES) within a Zero Trust Network (ZTNA) environment to provide advanced, dynamic, interpretable insights into customer interactions. The system may be configured to leverage strengths of SHAP to explain information and VAES for efficient data representation, ensuring both transparency and accuracy in analysis and interpretation of data insights. Further, the integration of SHAP with VAES provides an approach for dynamically standardizing output formats from artificial intelligence models and/or artificial intelligence algorithms. The system may be configured to prioritize certain communications between user device and workspace devices. The system utilizes VAES to learn latent representations of user device interactions and SHAP-based analyses to interpret these representations to generate actionable insights. Herein, the system is configured to generate and/or allocate weighted prioritization tags to communications based on corresponding insights. The insights serve to inform the priority order in which communication operations may be received at a workspace device.

In some embodiments, the VAES is configured to encode data from the user devices. This encoding allows for the generation of new data samples that resemble user device behavior, enabling the identification of patterns and trends. Further, the SHAP-based analyses are then applied to provide clear and interpretable explanations for generated insights, helping customer service agents understand underlying factors influencing customer satisfaction and inclination.

The Zero Trust Network Access (ZTNA) is configured to ensure access to user device data by verifying user device identity before granting access to communicate with a workspace device in the network. This approach enhances data privacy and security within the system because only communications from approved user devices are evaluated for exchange. The ZTNA may be configured to continuously monitor network activity and enforce strict access controls, preventing unauthorized access and ensuring that sensitive data remains protected.

In one or more embodiments, the systems and methods described herein are integrated into a practical application of dynamically routing communications using weighted prioritization tags. In one or more embodiments, the information shared may be processed as audio data exchanged between two or more devices in real time. In this regard, real time may refer to smaller delays (e.g., milliseconds, nanoseconds, and the like) between processing time after the audio data is obtained. The audio data may be transcribed into text data and/or image data. Herein, an artificial intelligence algorithm may be configured to structure the transcribed data in accordance with one or more artificial intelligence models, determine motivation from the structured version of the transcribed data, and generate one or more intents (e.g., target operations) based at least in part upon the structured version of the transcribed data. In some embodiments, the systems and methods are integrated into a practical application of actively determining one or more action item suggestions based on the identified intent behind the communication operations. The action item suggestions may be proposed operations to be performed at a workspace device. The action item suggestions and/or intents associated with the action items are weighted in order of importance to be prioritized selectively. In embodiments in which the communication operations comprise conversations exchanged between a user device and a workspace device, by dynamically providing action item suggestions at different prioritization levels, the system effectively performs one or more suggested action items as soon as intent is determined in a conversation in accordance with the prioritization levels.

The system may also be integrated into a practical application of providing enhanced security to network communications by intercepting information comprising format anomalies and preventing compromised information from reaching specific devices in the network. In some embodiments, the system brings together different types of data comprising different formats and modifies the different formats to reach a common format. Herein, the system provides a format transformation in which data is dynamically identified as comprising a specific format from a source and modified to match a destination format. In this regard, the system prevents mismatched formats and/or compromised data formats (containing format anomalies) to be received at specific processing engines. For example, the system may be configured to obtain multiple operation results from multiple artificial intelligence models. Each artificial intelligence model may output data comprising a corresponding format. At this stage, the system intercepts generated and/or output data and transforms the intercepted data to match a destination format. In some embodiments, examples of format anomalies may include irregular spacing, non-standard characters, and/or missing punctuations between the formats.

In one or more embodiments, the system is configured to intercept electronic data streams between at least two devices in the network and evaluate the contents found in the electronic data streams using multiple layers of evaluation protocols to determine whether the content comprises format anomalies. The layers of evaluation protocols may comprise a layer using autoencoders, one or more layers comprising trained artificial intelligence algorithms, one or more layers comprising artificial neural networks, and/or one or more layers comprising ZTNA of one or more layers of security protocols. In the event that format anomalies are detected, the systems are configured to drop electronic data streams found to comprise the format anomalies and block future communications from any transmitting devices determined to be associated with transmissions of compromised content (e.g., mismatching formats). By dropping these electronic data streams and blocking future communications from transmitting devices that are determined to be associated with transmitting compromised content, the systems and methods described herein enhance the security of the network and underlying computer systems, as well as reduce the propagation of malware, spyware, and other malicious communications.

Technical problems caused by format anomalies (e.g., mismatched formats) associated with outputs from artificial intelligence models may include: 1) reduced accuracy; 2) infiltration opportunities for attackers; and 3) computational inefficiencies. The anomalies may result from inconsistencies in data types, schemas, or data representation, forcing specific artificial intelligence models to make assumptions or pre-process data, which introduce adverse impact performance and inaccuracies in operations performed using artificial intelligence models and/or artificial intelligence algorithms.

With regards to 1), the system is configured to ensure that data is exchanged using a uniform format (e.g., same field names or data types for same information types). Herein, the system prevents, inhibits, and/or eliminates struggles from artificial intelligence models attempting to correctly interpret data from additional artificial intelligence models and/or artificial intelligence algorithms. In some embodiments, the system prevents mismatched formats from performing incorrect calculations or comparisons, which may result in inaccurate model outputs. Further, to increase accuracy in data exchanges and/or communications, the system is configured to organize system records with increased consistency, which prevents, inhibits, and/or eliminates misinterpretations of relationships between different pieces of information across multiple artificial intelligence models and/or artificial intelligence algorithms.

With regards to 2), the system inhibits and/or prevents bad actors (e.g., attackers using deepfakes maliciously to access a network), from infiltrating secured systems. Herein, the systems intercept communications directed to specific user devices in the network and evaluate content in the communications for data anomalies. If inconsistent format anomalies are found in data streams from a same source, the system may eliminate the communication streams between the source of the format anomalies and a target (e.g., local) user device. By identifying and eliminating communication streams that include such format anomalies, the systems and methods described herein reduce the volume of malicious traffic on networks, which simplifies the task of network security monitoring and incident response.

With regards to 3), the system inhibits and/or prevents inconsistent formatting from introducing noise and/or errors into input data used to train artificial intelligence models and/or artificial intelligence algorithms. Inconsistent formatting in data may lead to models and/or algorithms failing to learn effectively, resulting in poor or collapsing models. In current systems, inconsistencies in input data and/or training data may lead to artificial intelligence models and/or artificial intelligence algorithms to generate incorrect and/or nonsensical outputs.

In addition, the system reduces processor and memory usage in a server by reducing network resources consumed during communication operations. Herein, communication operations may consume (e.g., use) network resources each time data is exchanged. The network resources may comprise power resources, memory resources, and/or processing resources. Herein, the systems and methods reduce consumption of network resources because communication operations are made more efficient. As intent behind the communication operations is determined in real time, action item suggestions may be determined and performed to conclude communication operations. After an action item suggestion is generated, the workspace device may be configured to suggest the action item as a targeted operation to the user device that may trigger a conclusion of the communication operations.

In one or more embodiments, the systems and the methods may be performed by an apparatus, such as the server. Further, the system may be a data exchange system, which comprises the apparatus. In addition, the system and the method may be performed as part of a process performed by the apparatus. As a non-limiting example, the apparatus may comprise a memory and a processor communicatively coupled to one another. The memory may be operable to store multiple previous topics comprised in previous data exchange operations performed by a user device and multiple weighted prioritization tags used to prioritize one or more of the previous data exchange operations performed by the user device.

The processor may be configured to intercept a data stream exchanged between the user device and a workspace device. The data stream may comprise a communication packet as part of a current data exchange operation. Further, the processor may be configured to electronically extract a current topic associated with the current data exchange operation, train, during a first phase, an artificial intelligence algorithm using first input data comprising historical data of the previous data exchange operations associated with the user device, the plurality of previous topics, and the weighted prioritization tags.

In addition, the processor may be configured to, using the trained artificial intelligence algorithm, determine whether the current topic matches a previous topic in the previous topics. The processor may be configured to assign a weighted prioritization tag associated with the previous topic to the current topic in response to determining that the current topic matches the previous topic in the previous topics and electronically extract an insight from the current data exchange operation. The processor may be configured to modify a value of the weighted prioritization tag assigned to the current topic based at least in part upon the insight, generate an explanation file reporting an insight type associated with the insight and an impact of the insight type in the value of the weighted prioritization tag, and queue the communication packet for interaction with the workspace device at a queue position. The queue position may be based at least in part upon a modified value of the weighted prioritization tag. After receiving the communication packet, the workspace device may be configured to perform multiple sub-operations triggered by the current data exchange operation.

In some embodiments, the processor may be configured to train, during a second phase, the artificial intelligence algorithm using second input data comprising the historical data of the previous data exchange operations associated with the user device, the current data exchange operation, the plurality of previous topics, the plurality of weighted prioritization tags, and the explanation file.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a system in accordance with one or more embodiments; and

FIG. 2 illustrates an example flowchart of a method performed by the system of FIG. 1 in accordance with one or more embodiments.

### DETAILED DESCRIPTION

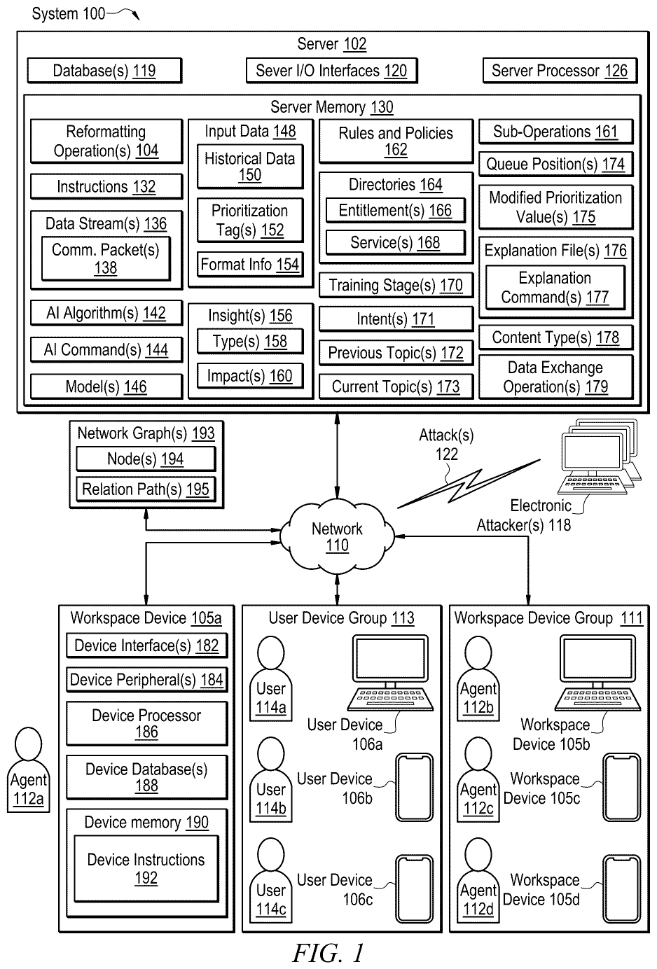

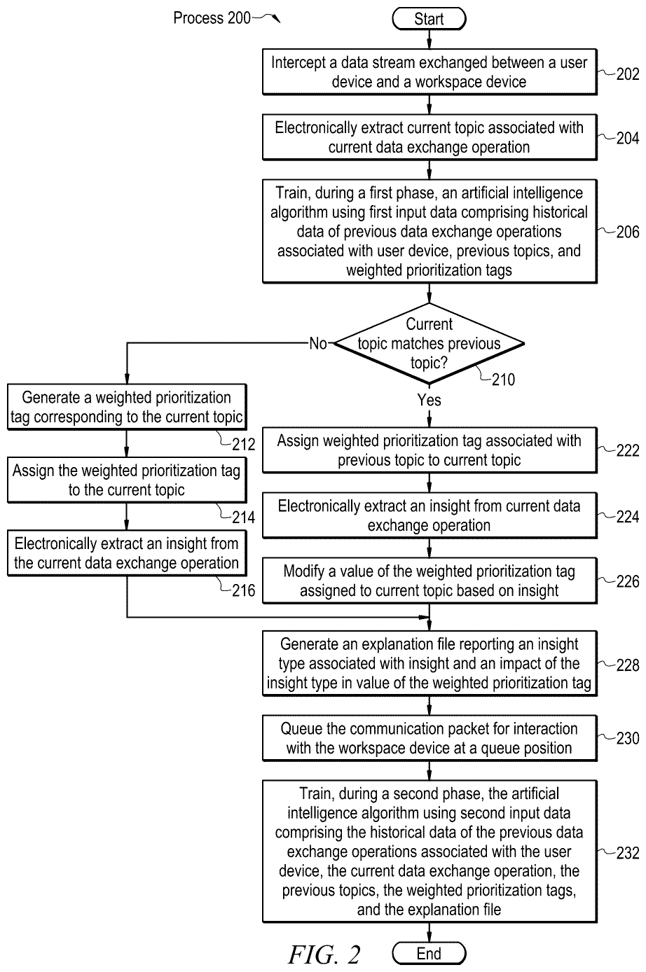

As described above, this disclosure provides various systems and methods to dynamically route communications using weighted prioritization tags. FIG. 1 illustrates a system 100 in which a server 102 is configured to perform multiple reformatting operations 104. FIG. 2 illustrates a process 200 performed by the system 100 of FIG. 1.

### System Overview

FIG. 1 illustrates an example system 100, in accordance with one or more embodiments. The system 100 may comprise a server 102 configured to dynamically route communications using weighted prioritization tags. In the system 100 of FIG. 1, the server 102 is communicatively coupled to multiple workspace devices 105a-105d (collectively, workspace devices 105) and multiple user devices 106a-106c (collectively, user devices 106) via a network 110. In some embodiments, the workspace device 105a is a standalone device, while the workspace device 105b, the workspace device 105c, and the workspace device 105d may be incorporated in a workspace device group 111. Each of the workspace device 105a, the workspace device 105b, the workspace device 105c, and the workspace device 105d may be operated by an agent 112a, an agent 112b, an agent 112c, and an agent 112d, respectively. The workspace device group 111 may comprise less or more workspace devices 105 than those shown in FIG. 1. Further, the user device 106a, the user device 106b, and the user device 106c may be incorporated in a user device group 113. Each of the user device 106a, the user device 106b, and the user device 106c may be operated by a user 114a, a user 114b, and a user 114c, respectively. The user device groups 113 may comprise less or more user devices 106 than those shown in FIG. 1.

In one or more embodiments, the server 102 comprises the databases 119, a server input (I)/output (O) interfaces 120, at least one server processor 126 comprising a processing engine (not shown), and a server memory 130. In some embodiments, the databases 119 may be standalone memory storage units or part of the server memory 130. In some embodiments, the server memory 130 may be operable to store instructions 132, one or more reformatting operations 104, one or more data streams 136 comprising one or more communication packets 138, one or more artificial intelligence (AI) algorithms 142, one or more AI commands 144, one or more models 146, input data 148 comprising historical data 150, one or more prioritization tags 152, and one or more format information 154, one or more insights 156 comprising one or more types 158 and one or more impacts 160, and one or more rules and policies 162. Further, the server memory 130 may be operable to store one or more directories 164 comprising one or more entitlements 166 and one or more services 168, one or more training stages 170, one or more intents 171, one or more previous topics 172, one or more current topics 173, one or more queue positions 174, one or more modified prioritization values 175, one or more explanation files 176 comprising one or more explanation commands 177, one or more content types 178, and one or more data exchange operations 137.

Referring to the workspace device 105a as a non-limiting example of the workspace devices 105, the workspace devices 105 may comprise one or more device interfaces 182, one or more device peripherals 184, a device processor 186, one or more device databases 188, and a device memory 190. The device memory 190 may comprise multiple device instructions 192. The user devices 106 may comprise one or more elements and/or components described in reference to the workspace device 105a.

The workspace devices 105 and the user devices 106 may be user nodes configured to trigger exchanges of data and/or perform one or more communication operations with the server 102 via the network 110. The workspace devices 105 and the user devices 106 may be working nodes configured to receive instructions to perform one or more communication operations based on instructions received from the server 102. In some embodiments, some of the workspace devices 105 and/or the user devices 106 may be clustered together in one or more groups (e.g., the workspace device group 111 and the user device group 113). Each of the workspace devices 105 and/or the user devices 106 may be associated with one or more corresponding operators (e.g., the agents 112 and the users 114).

In one or more embodiments, the example of FIG. 1 shows electronic attackers 118 attempting to perform one or more attacks 122. In some embodiments, some of the electronic attackers 118 may be clustered together in one or more attacker groups. In FIG. 1, the attacker group may comprise multiple electronic attackers. These electronic attackers 118 may be bad actors attempting to perform one or more attacks 122 to the server 102, the workspace devices 105, the user devices 106, the network 110, the workspace device group 111, and/or the user device groups 113.

In some embodiments, the system 100 may comprise one or more network graphs 193. The network graphs 193 may be communicatively coupled to the server 102, the workspace devices 105 in the workspace device group 111, and/or the user devices 106 in the user device group 113 via the network 110. In the example of FIG. 1, the network graphs 193 comprise one or more nodes 194 and one or more relation paths 195.

### System Components

### Server

The server 102 is generally any device or apparatus that is configured to process data and communicate with computing devices (e.g., the workspace devices 105 and/or the user devices 106), additional databases, systems, and the like, via the one or more server I/O interfaces 120 (i.e., a user interface or a network interface). The server 102 may comprise the server processor 126 that is generally configured to oversee operations of the processing engine. The operations of the processing engine are described further below in conjunction with the system 100 described in FIG. 1, and the process 200 described in FIG. 2.

The server 102 comprises multiple databases 119 configured to provide one or more memory resources to the server 102, the workspace devices 105, and/or and the user devices 106. The server 102 comprises the server processor 126 communicatively coupled with the databases 119, the server I/O interfaces 120, and the server memory 130. The server 102 may be configured as shown, or in any other configuration. In one or more embodiments, the databases 119 are configured to store data that enables the server 102 to configure, manage and coordinate one or more middleware systems. In some embodiments, the databases 119 store data used by the server 102 to function as a halfway point in between applications and other tools or databases.

In one or more embodiments, the databases 119 may be one of the server databases in one of the managed servers. In one example, the server 102 may determine the server processor 126 is available (e.g., running) to perform a specific server application (e.g., service). In another example, the server 102 may determine that a specific managed server is running to perform a specific server application after receiving a server response indicating that a corresponding managed server is available to perform the server application. In one or more embodiments, the server 102 may determine whether a specific device processor 186 is available (e.g., running) to perform one or more specific local applications. In yet another example, the server 102 may determine that the databases 119 are running to provide memory resources to execute server applications receiving a database response indicating that the databases 119 are available to provide memory resources to execute the server applications. In one or more embodiments, the server 102 may determine whether the databases 119 are available (e.g., running) and may provide the database response. In one or more embodiments, one of the managed servers may determine whether the corresponding databases 119 are available (e.g., running) and may provide the database response.

In one or more embodiments, the server I/O interfaces 120 may be configured to enable wired and/or wireless communications. The server I/O interfaces 120 may be configured to communicate data between the server 102 and other devices (i.e., the workspace devices 105 and/or the user devices 106), network devices (i.e., routers in the network 110), systems, or domain(s) via the network 110. For example, the server I/O interfaces 120 may comprise a wireless fidelity (WI-FI) interface, a local area network (LAN) interface, a wide area network (WAN) interface, a modem, a switch, or a router. The server processor 126 may be configured to send and receive data using the server I/O interfaces 120. The server I/O interfaces 120 may be configured to use any suitable type of communication protocol. In some embodiments, the server I/O interfaces 120 may be an admin console comprising a display configured to show a user interface used to manage a middleware server domain via the server 102. A middleware server domain may be a logically related group of workspace devices 105 that are managed as a unit. A middleware server domain may comprise the server 102 and one or more workspace devices 105. The workspace devices 105 may be standalone devices and/or collected devices in a workspace device group 111. The workspace device group 111 may be a group of managed workspace devices 105 that work together to provide scalability and higher availability for server and/or workspace applications. In this regard, the server and/or workspace applications may be provisioned and deployed as part of at least one domain. In other embodiments, one instance of the workspace devices 105 in the middleware server domain may be configured as the server 102. The server 102 provides a central point for managing and configure the workspace devices 105, any of the one or more server and/or workspace applications.

The at least one server processor 126 may comprise one or more processors communicatively coupled to the server memory 130. The server processor 126 may be any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The server processor 126 may be a programmable logic device, a microcontroller, a microprocessor, or any suitable combination of the preceding. The one or more server processors 126 may be configured to process data and may be implemented in hardware or software executed by hardware. For example, the server processor 126 may be 8-bit, 16-bit, 32-bit, 64-bit or of any other suitable architecture. The server processor 126 may include an arithmetic logic unit (ALU) for performing arithmetic and logic operations, processor registers that supply operands to the ALU and store the results of ALU operations, and a control unit that fetches the instructions 132 from the server memory 130 and executes them by directing the coordinated operations of the ALU, registers and other components. In this regard, the one or more server processors 126 are configured to execute various instructions. For example, the one or more server processors 126 are configured to execute the instructions 132 to implement the functions disclosed herein, such as some or all of those described with respect to FIGS. 1-3B. In some embodiments, the functions described herein are implemented using logic units, FPGAs, ASICs, DSPs, or any other suitable hardware or electronic circuitry.

In one or more embodiments, the server I/O interfaces 120 may be any suitable hardware and/or software to facilitate any suitable type of wireless and/or wired connection. These connections may include, but not be limited to, all or a portion of network connections coupled to the Internet, an Intranet, a private network, a public network, a peer-to-peer network, the public switched telephone network, a cellular network, a local area network (LAN), a metropolitan area network (MAN), a wide area network (WAN), and a satellite network. The server I/O interfaces 120 may be configured to support any suitable type of communication protocol as would be appreciated by one of ordinary skill in the art.

The server memory 130 may be volatile or non-volatile and may comprise a read-only memory (ROM), random-access memory (RAM), ternary content-addressable memory (TCAM), dynamic random-access memory (DRAM), and static random-access memory (SRAM). The server memory 130 may be implemented using one or more disks, tape drives, solid-state drives, and/or the like. The server memory 130 may be operable to store the instructions 132, the one or more reformatting operations 104, the one or more data streams 136 comprising the one or more communication packets 138, the one or more AI algorithms 142, the one or more AI commands 144, the one or more models 146, the input data 148 comprising the historical data 150, the one or more prioritization tags 152, and the one or more format information 154, the one or more insights 156 comprising the one or more types 158 and the one or more impacts 160, and the one or more rules and policies 162. Further, the server memory 130 may be operable to store the one or more directories 164 comprising the one or more entitlements 166 and the one or more services 168, the one or more training stages 170, the one or more intents 171, the one or more previous topics 172, the one or more current topics 173, the one or more queue positions 174, the one or more modified prioritization values 175, the one or more explanation files 176 comprising the one or more explanation commands 177, the one or more content types 178, and the one or more data exchange operations 137. The instructions 132 may comprise any suitable set of instructions, logic, rules, or code operable to execute the server processor 126.

The one or more data exchange operations 137 may be one or more data exchanges performed between two or more workspace devices 105 and/or user devices 106 in the system 100. In one or more embodiments, the data exchange operations 137 may be audio communications exchanged as part of audio conversations (e.g., during a telephonic call) between two or more workspace devices 105 and/or user devices 106. The data exchange operations 137 may be image and/or text communications exchanged as part of image-based conversations (e.g., during videocalls and/or chat exchanges) between two or more user devices. The one or more data exchange operations 137 may be one or more operations executed by the server processor 126 configured to enable data objects to be exchanged between the workspace devices 105, the user devices 106, and/or the server 102. In one or more embodiments, the data exchange operations 137 may be configured to indicate one or more data objects to be exchanged between the server 102 and at least one of the workspace devices 105 and/or the user devices 106. The server 102 may be configured to generate and analyze one or more data exchange operations 137 to confirm whether one or more workspace devices 105 and/or user devices 106 associated with data exchange operations 137 are legitimately associated with at least one of the user devices 106. The server 102 may be configured to perform one or more operations in which the server 102 is configured to confirm whether one or more data exchange operations 137 belong to a specific workspace device 105 and/or user device 106.

The electronic data streams 136 may be one or more continuous and/or intermittent flows of data packets, information, and/or any data elements exchanged as part of one or more of the data exchange operations 137. The electronic data streams 136 may comprise data that is transmitted in packets (e.g., communication packets 138). The electronic data streams 136 may be used to analyze data in real-time to gain insights 156 into a the one or more operations. The electronic data streams 136 may be exchanged between workspace devices 105, user devices 106, and/or workspace devices 105 and user devices 106 at different rates of speed. The rates of speed may be in the magnitudes of bits per second, bits per minute, and the like. The electronic data streams 136 may comprise multiple data types such as sound data, image data, and the like. The electronic data streams 136 may comprise a single data stream or multiple data streams combined into a single transmission. The electronic data streams 136 may be configured to provide one or more of the streams to different user devices 106. In some embodiments, communication packets 138 in the electronic data streams 136 may be transmitted individually and/or in batches. The communication packets 138 in the electronic data streams 136 may comprise multiple formats, resolutions, and/or configuration aspects.

In one or more embodiments, the communication packets 138 may comprise image data, text data, and/or a combination of multiple data types. The communication packets 138 may be representative of contextual information associated with the one or more workspace devices 105 and/or user devices 106. The communication packets 138 may comprise descriptive information about a resource, such as title, abstract, author, and/or related keywords. The communication packets 138 may comprise contextual information about containers of data and indicates how compound objects are put together comprising data types, data versions, data relationships, and other data characteristics of digital materials. The communication packets 138 may comprise information to help manage a resource, such as a resource type, resource permissions, and/or creation data. The communication packets 138 may comprise information about contents and quality of statistical data. The communication packets 138 may comprise process data associated with collection, processing, and/or production of statistical data.

The communication packets 138may be one or more packets of information. The communication packets 138 may comprise information in the form of image data. The communication packets 138 may be obtained from training materials provided to, or obtained by, the server 102.

In one or more embodiments, audio data received from a user device 106 may be handled by a voice gateway configured to forward audio streams to a speech-to-text model. The server 102 may be configured to use a speech-to-text model. The speech-to-text model may be an AI model (e.g., model 146) configured to filter out background noise in an audio stream and identify human speech and execute a trained AI algorithm 142 to transcribe the audio data associated with the human speech. The transcribed version of the audio data may be image data and/or text data. The server 102 may be configured to use an image-to-text model. The image-to-text model may be an AI model configured to filter out background noise in an image stream and/or a video stream and execute a trained AI algorithm 142 to transcribe the image data associated with the communication operations. The transcribed version of the image data may be text data. At this stage, the AI algorithm 142 may be executed in accordance with a call purpose summarization model to summarize the transcribed data and generate one or more summaries as a result. The AI algorithms 142 may be executed in accordance with a classification model to determine information and/or communication categories associated with the audio data and/or image data. The AI algorithms 142 may be configurated to evaluate the summaries in accordance with a dedicated model to extract entities (e.g., names, dates, accounts, amounts, numbers, and the like) from the summaries.

In one or more embodiments, the server 102 is configured to identify one or more communication operations (e.g., including one or more data exchange operations 179), determine audio data and/or image data in the communication operations, and generate one or more summaries based on the audio data and/or image data. The summaries may be configured to represent a purpose behind the audio data and/or image data. As the communication operations continue, subsequent audio data and/or image data is used to generate additional summaries. For each of the summaries, the server 102 may be configured to determine one or more intents 171 from at least a portion of the communication operations. As the summaries are obtained, additional intents 171 may be determined over time. As each of the intents 171 are determined, the server 102 may be configured to evaluate each of the intents 171 to identify potential action item suggestions with respect to a starting point (e.g., a starting intent). At a time when the server 102 starts obtaining the audio data and/or image data, a first intent 171 associated with a first action item may be the starting point. In some embodiments, insights 156 may be obtained from intents 171 determined in isolation and/or in accumulation after considering a sequence of intents 171. In one or more embodiments, the intents 171 may be one or more target operations configured to be performed as part of one or more data exchange operations 137 in the communication network. The server 102 may be configured to generate one or more suggestions comprising action items to perform, start, trigger, and/or complete the target operations. In some embodiments, the server 102 may be configured to evaluate the target operations and determine an intent 171 based on the target operations.

The input data 148 may be one or more data elements and/or data records configured to provide one or more input training for the one or more AI algorithms 142. The input data 148 may be configured to include historical data 150, one or more prioritization tags 152, and/or format information 154. The historical data 150 may be historic information associated with one or more user devices 106 in a communication network comprising several communication sites. The historical data 150 may comprise one or more reference datapoints representing one or more trends associated with communication operations associated with a specific user device 106, a user device group 113 of user devices 106, and/or several user devices 106 associated with one or more device profiles in the communication network. The historical data 150 may be feedback data that is previously processed and determined to match device information associated with one or more device profiles. The reference datapoints may be one or more datapoints that are previously processed and determined to match device information associated with one or more device profiles. The one or more prioritization tags 152 may be one or more indicators configured to reference a communication level and/or a prioritization level configured to trigger one or more specific sub-operations 161. The prioritization tags 152 may be weighted values configured to reference that multiple portions of the communication packets 138 correspond to specific queue positions 174. The server 102 may be configured to generate one or more prioritization tags 152 for one or more of the specific sub-operations 161. The prioritization tags 152 may be configured to comprise guidance to generate and/or eliminate one or more of the sub-operations 161. In some embodiments, the sub-operations 161 may comprise one or more operations performed in a workspace device 105 after receiving a portion of a data stream 136.

In one or more information, the format information 154 may represent one or more aspects of a format associated with a manner in which data is presented. In particular, the format information 154 may represent formatting associated with specific portions of the data streams 136. The format information 154 may be configured to reference a size, a use of numerals and/or letters, and message structure for multiple data elements and data records exchanged in the system 100.

The reformatting operations 104 may be one or more operations in which a specific format of specific communicated information is changed from a first format to a second format. The reformatting operations 104 are configured to determine format information 154 associated with intercepted data in one or more of the data exchange operations 179. The reformatting operations 104 may be configured to match a first format associated with a source of the intercepted data to a second format associated with a destination for the intercepted data. In some embodiments, the reformatting operations 104 integrate SHapely Additive exPlanations (SHAP) to explain outputs from certain AI models and/or AI algorithms. By integrating the SHAP, the reformatting operations 104 provides clear and interpretable insights 156 into sentiment predictions associated with data exchange operations 179. Herein, the SHAP quantifies contributions of each feature of the intercepted data to an intent 171, enabling understanding of underlying factors. The SHAP values may be used to interpret contribution of individual features to a sentiment analysis model configured to determine intents 171 and/or insights 156 associated with data exchange operations 179.

In one or more embodiments, the reformatting operations 104 comprise intercepting information comprising format anomalies and preventing compromised information from reaching specific devices via the network 110. In some embodiments, the reformatting operations 104 brings together different types of data comprising different formats and modifies the different formats to reach a common format. Herein, the reformatting operations 104 provide a format transformation in which data is dynamically identified as comprising a specific format from a source and modified to match a destination format. In this regard, the reformatting operations 104 is configured to prevent mismatched formats and/or compromised data formats (containing format anomalies) to be received at specific processing engines. For example, the reformatting operations 104 may comprise obtaining multiple operation results from multiple models 146. Each model 146 may output data comprising a corresponding format. At this stage, the reformatting operations 104 may include intercepting generated and/or output data and transforming the intercepted data to match a destination format. In some embodiments, examples of format anomalies may include irregular spacing, non-standard characters, and/or missing punctuations between the formats. The format anomalies may be one or more abnormal, peculiar, and/or unexpected aspects of a document format and/or an image format. The format anomalies may be one or more deviations in an expected image and/or document format. For example, a format anomaly in an image may be a resolution than an expected resolution.

In one or more embodiments, the reformatting operations 104 comprise intercepting electronic data streams 136 between at least two devices communicatively coupled in the network 110 and evaluating the contents found in the electronic data streams 136 using multiple layers of evaluation protocols (e.g., VAES, SHAP, and ZTNA) to determine whether the content comprises format anomalies. The layers of evaluation protocols may comprise a layer using autoencoders, one or more layers comprising trained AI algorithms 142, one or more layers comprising artificial neural networks, and/or one or more layers comprising ZTNA of one or more layers of security protocols. In the event that format anomalies are detected, the reformatting operations 104 comprise dropping electronic data streams 136 found to comprise the format anomalies and block future communications from any transmitting devices determined to be associated with transmissions of compromised content (e.g., mismatching formats).

The reformatting operations 104 comprise ensuring that data is exchanged using a uniform format (e.g., same field names or data types for same information types). Herein, the reformatting operations 104 prevents, inhibits, and/or eliminates struggles from AI models and/or layers of evaluation protocols attempting to correctly interpret data from additional AI models and/or AI algorithms 142.

The one or more insights 156 may be one or more technical aspects associated with the contents of information exchanged in data exchange operations 179. In some embodiments, the insights 156 may reference an order in which information is presented in the data exchange operations 179. The insights 156 may include text, images, and/or a combination of both. The insights 156 may include aspects of one or more isolated text characters and/or shapes. The insights 156 may be one or more intents 171 determined and/or identified in association with one or more communication operations between the server 102, one or more of the workspace devices 105, and/or the user devices 106. The insights 156 may comprise one or more key points and/or key words that reference operations that triggered and/or started a given communication operation. Key points and/or key words may be searched in content exchanged in the communication operations to determine specific insight types 158 in exchanged information between the server 102, one or more of the workspace devices 105, and/or the user devices 106. The insight types 158 may indicate and/or reference one or more aspect of the communication operations. The insight types 158 may relate one or more tasks, goals, and/or resources associated with specific performance and/or operations in the server 102, the workspace devices 105, and/or the user devices 106. The insights 156 may be associated with one or more impacts 160 that are evaluated against knowledge bases to determine a relative importance of information associated with the insight 156. If the insight 156 is determined to be associated with a knowledge base that is associated with multiple devices in the system 100, the insight 156 is assigned a higher impact 160. If the insight 156 is determined to be associated with a knowledge base that is associated with few devices in the system 100, the insight 156 is assigned a lower impact 160.

In one or more embodiments, the insight 156 may be generated based on one or more aspects of audio, text, and/or image data collected in the data exchange operations 179. For example, the insight 156 of an audio recording captured during an audio call may include an inflexion level in a voice from a user 114, perceived emotions in the voice from the user 114 as determined by the network graphs 193, and/or context information preceding the captured audio.

In one or more embodiments, the system 100 is configured to dynamically assign prioritization tags 152 to data exchange operations 179 based on a perceived intent 171 and/or insight 156. The prioritization tags 152 may be stored and/or used to reference a priority level in which the data exchange operation 179 is transmitted and/or delivered to a receiving workspace device 105. The workspace device 105 may be configured to account for the contents of previous topics 172 and/or current topics 173 found in the data exchange operations 179. The previous topics 172 and/or current topics 173 may be knowledge bases associated with the data exchange operations 179. The previous topics 172 may be associated with previous data exchange operations 179. The current topics 173 may be associated with current data exchange operations 179.

The queue positions 174 may be positions in a line in which one or more sub-operations 161 derived from the data exchange operations 179 are performed and/or implemented by a workspace device 105. The queue positions 174 may be determiner and/or correspond to a prioritization tag 152. In some embodiments, prioritization tags 152 may be set for specific previous topics 172 based on prior processing of data exchange operations 179. Further, prioritization tags 152 may be modified (to generate one or more modified prioritization values 175) for specific current topics 173 based on prior processing of data exchange operations 179.

In one or more embodiments, the intents 171 may be one or more target operations that are expected to be performed as part of one or more data exchange operations and/or one or more communication operations performed in the communication network. The server 102 may be configured to generate one or more suggestions comprising action items to perform, start, trigger, and/or complete the target operations. In some embodiments, the server 102 may be configured to evaluate a sequence of target operations and determine subsequent intents 171 based on the sequence of target operations.

In one or more embodiments, the SHAP offers a consistent method for attributing influence of individual features in intercepted data, allowing for reliable interpretation of model outputs across different datasets. In some embodiments, the server 102 may be configured to implement a real-time feedback loop mechanism that dynamically adjusts sentiment interpretations based on specific information contained in the data exchange operations 179.

In one or more embodiments, one or more Variational Autoencoders (VAEs) may assist into efficient data encoding. The one or more VAEs may be configured to encode intercepted data exchange operations into a continuous, probabilistic latent space, capturing complex patterns and relationships within the data. The efficient data representation facilitates the identification of meaningful trends in behavior associated with a source of the data. Further, the VAEs may be configured to electronically extract and encode relevant features from exchanged data, enhancing performance and interpretability of the data.

In one or more embodiments, one or more Zero Trust Network Access (ZTNA) operations ensure dynamic access to sensitive data in the data exchange operations 179 by verifying identity of users 114 and user devices 106 before granting access between the user devices 106 and any one of the workspace devices 105. In some embodiments, the ZTNA may continuously monitor network activity and enforce strict access controls, preventing unauthorized access and ensuring that sensitive data remains protected.

The explanation files 176 may be a reporting document comprising reporting of an insight type 158 associated with the insight 156 and an impact 160 of the insight type 158 in the value of a weighted prioritization tag 152 (e.g., a modified prioritization value 175). The explanation commands 177 may be guidance for one or more of the workspace devices 105. The explanation commands 177 may be local explanation commands that comprise guidance to respond to the current data exchange operation 179. The explanation commands 177 may be global explanation commands that comprise guidance to respond to future data exchange operations 179 comprising a same insight type 158.

In one or more embodiments, the server 102 is configured to provide a robust and transparent method of explaining decision-making process in sentiment analysis, ensuring that workspace devices 105 receive information on how and why specific customer sentiments are interpreted to generate intents 171 and/or insights 156.

In one or more embodiments, an analysis architecture comprises the AI algorithms 142, the AI commands 144, and the models 146. The AI algorithms 142 may be executed by the server processor 126 to evaluate the audio data and/or the image data and/or perform one or more of the communication operations in accordance with one or more models 146. Further, the AI algorithms 142 may be configured to interpret and transform the audio data, the image data, and/or the text data into structured data sets and be subsequently stored as files or tables. The AI algorithms 142 may cleanse, normalize raw data, and derive intermediate data to generate uniform data in terms of encoding, format, and data types. The AI algorithms 142 may be executed to run user queries and advanced analytical tools on the structured data. The AI algorithms 142 may be one or more machine learning algorithms configured to process the input data 148 as part of one or more training operations. The AI algorithms 142 may be configured to perform one or more operations aided by neural networks configured to provide association and/or connections between one or more data elements and data records. The neural networks may be equipped with one or more dedicated processors and/or memory storages distributed over multiple processing nodes. Each processing node may be a device configured to provide specialized content analysis in association with an input. In some embodiments, the AI algorithms 142 encompass various techniques, including supervised learning (e.g., trained on labeled data), unsupervised learning (e.g., analyzing unlabeled data), reinforcement learning (e.g., learning through trial and error), and deep learning (e.g., using complex models with hidden layers) among others. The AI algorithms 142 may be trained to perform one or more specialized analyses. The AI commands 144 may be one or more commands generated using one or more AI algorithms 142. The AI commands 144 may be configured to be one or more updates to the instructions 132. The AI commands 144 may be control commands, data signals, and/or configuration triggers configured to cause one or more elements stored in the server 102, the workspace devices 105, and/or the user devices 106. The models 146 may be one or more training protocols and/or structures to perform one or more operations in the system 100. The models 146 may be one or more instruction sets trained and/or created using the AI algorithms 142. The models 146 may be trained on a set of data to recognize certain patterns and/or make certain decisions autonomously. The models 146 may be configured to apply different AI algorithms 142 to relevant data inputs to achieve target tasks and/or outputs. In some embodiments, the models 146 may be defined by an ability to autonomously make decisions or predictions.

In one or more embodiments, the AI algorithms 142 may be trained over multiple training stages 170. The training stages 170 may be different to one another. Over time, the server 102 may be configured to trigger one or more updates to the AI algorithms 142, one or more AI commands 144, and/or one or more models 146. The training stages 170 may be configured to provide specific parameterization to the AI algorithms 142 at each stage.

The rules and policies 162 may be security configuration commands or regulatory operations predefined by an organization or one or more users 116. In one or more embodiments, the rules and policies 162 may be dynamically defined by the one or more agents 112 and/or one or more users 114. The rules and policies 162 may be prioritization rules configured to instruct one or more workspace devices 105 and/or one or more user devices 106 to perform one or more evaluating operations or perform one or more sub-operations 161 in the system 100 in a specific communication operation. The one or more rules and policies 162 may be predetermined or dynamically assigned by a corresponding agent 112, a corresponding user 116, or an organization associated with the agents 112 or the users 116.

The directories 164 may comprise the one or more user profiles and/or agent profiles, one or more entitlements 166 and one or more services 168. In one or more embodiments, the user profiles and/or agent profiles may comprise multiple profiles associated with one or more entitlements 166 to access and/or modify the services 168. Each of the user profiles and/or agent profiles may be associated with one or more entitlements 166. The entitlements 166 may indicate that a given user device 106 is allowed to access one or more network resources in accordance with the one or more rules and policies 162. The entitlements 166 may indicate that a given user device 106 is allowed to perform one or more operations in the system 100 (e.g., provide a specific application data access to one of the users 114). To secure or protect operations of the user devices 106 from bad actors, the entitlements 166 may be assigned to a given user profile and/or agent profiles in accordance with updated security information, which may provide guidance parameters to the use of the entitlements 166 based at least upon corresponding rules and policies 162. In one or more embodiments, the one or more services 168 are access to one or more application operations performed in accordance with the application data. In some embodiments, the user profiles and/or agent profiles may comprise multiple profiles for users (e.g., user 114). Each user profile and/or agent profiles may comprise one or more entitlements 166. As described above, the entitlements 166 may indicate that a given user 114 is allowed to access one or more network resources in accordance with one or more rules and policies 162. The entitlements 166 may indicate that a given user is allowed to perform one or more data exchanges in the system 100. In one or more embodiments, each of the user profiles and/or agent profiles may comprise information about at least one user 114 entitled to trigger one or more data exchange operations and/or communication operations.

In one or more embodiments, the server databases 119 may be one or more repositories configured to store information. In one example, the server 102 may determine the server processor 126 is available (e.g., running) to perform a specific service. In another example, the server 102 may determine that a specific managed server is running to enable a testing application and/or perform the specific service upon receiving a server response indicating that a corresponding managed server is available to perform the service. The server databases 119 may be configured to store one or more representations of data instead of storing coded data. In this regard, the representations may be encoded in accordance with an encoder configured to identify and/or verify exchanged information.

### Network

The network 110 facilitates communication between and amongst the various devices of the system 100. The network 110 may be any suitable network operable to facilitate communication between the server 102, the workspace devices 105, and the user devices 106 of the system 100. The network 110 may include any interconnecting system capable of transmitting audio, video, signals, data, data packets, messages, or any combination of the preceding. The network 110 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the devices.

### Workspace Devices

In one or more embodiments, each of the workspace devices 105 (e.g., the workspace devices 105a-105d) may be any computing device configured to communicate with other devices, such as the server 102, other workspace devices 105 in additional workspace device groups 111, the user devices 106 in the user device group 113, other user devices 106 in additional user devices 106, databases, and the like in the system 100. Each of the workspace devices 105 may be configured to perform specific functions described herein and interact with one or more workspace devices 105b-105d in the user device group 113. Examples of the workspace devices 105 comprise, but are not limited to, a laptop, a computer, a smartphone, a tablet, a smart device, an IoT device, a simulated reality device, an augmented reality device, or any other suitable type of device. In this regard, each of the workspace devices 105 may be associated with one or more specific roles within an organization. Further, each of the workspace devices 105 may comprise access and/or connectivity to one or more elements of the messaging network in accordance with corresponding device roles.

The workspace devices 105 may be hardware configured to create, transmit, and/or receive information. The workspace devices 105 may be configured to receive inputs from a user, process the inputs, and generate data information or command information in response. The data information may include documents or files generated using a user interface. The command information may include input selections/commands triggered by a user using a peripheral component or one or more device peripherals 184 (i.e., a keyboard) or an integrated input system (i.e., a touchscreen presenting a user interface). The workspace devices 105 may be communicatively coupled to the server 102 via a network connection (i.e., one or more of the device interfaces 182). The workspace devices 105 may transmit and receive data information, command information, or a combination of both to and from the server 102 via the device interfaces 182. In one or more embodiments, the workspace devices 105 is configured to exchange data, commands, and signaling with the server 102. In some embodiments, the workspace devices 105 are configured to trigger the start of one or more communication operations. The workspace devices 105 may be configured to trigger network devices to perform one or more communication operations. In one or more embodiments, while FIG. 1 shows the workspace device 105b, the workspace device 105c, and the workspace device 105d, a given workspace device group 111 may comprise less or more workspace devices 105.

In one or more embodiments, referring to the workspace device 105a as a non-limiting example of the workspace devices 105, the workspace device 105a may comprise one or more device interfaces 182, one or more device peripherals 184, a device processor 186, the device databases 188, and a device memory 190. The device interfaces 182 may be any suitable hardware or software (e.g., executed by hardware) to facilitate any suitable type of communication in wireless or wired connections. These connections may comprise, but not be limited to, all or a portion of network connections coupled to additional workspace devices 105b-105d, the server 102, the user devices 106, the Internet, an Intranet, a private network, a public network, a peer-to-peer network, the public switched telephone network, a cellular network, a LAN, a MAN, a WAN, and a satellite network. The device interfaces 182 may be configured to support any suitable type of communication protocol.

In one or more embodiments, the one or more device peripherals 184 may comprise audio devices (e.g., speaker, microphones, and the like), input devices (e.g., keyboard, mouse, and the like), or any suitable electronic component that may provide a modifying or triggering input to the workspace device 105a. For example, the one or more device peripherals 184 may be speakers configured to release audio signals (e.g., voice signals or commands) during media playback operations. In another example, the one or more device peripherals 184 may be microphones configured to capture audio signals from the agent 112a. In one or more embodiments, the one or more device peripherals 184 may be configured to operate continuously, at predetermined time periods or intervals, or on-demand.

The device processor 186 may comprise one or more processors communicatively coupled to and in signal communication with the device interfaces 182, the device peripherals 184, the device databases 188, and the device memory 190. The device processor 186 is any electronic circuitry, including, but not limited to, state machines, one or more CPU chips, logic units, cores (e.g., a multi-core processor), FPGAs, ASICs, or DSPs. The device processor 186 may be a programmable logic device, a microcontroller, a microprocessor, or any suitable combination of the preceding. The one or more processors in the device processor 186 are configured to process data and may be implemented in hardware or software executed by hardware. For example, the device processor 186 may be an 8-bit, a 16-bit, a 32-bit, a 64-bit, or any other suitable architecture. The device processor 186 comprises an ALU to perform arithmetic and logic operations, processor registers that supply operands to the ALU, and store the results of ALU operations, and a control unit that fetches software instructions such as device instructions 192 from the device memory 190 and executes the device instructions 192 by directing the coordinated operations of the ALU, registers, and other components via a device processing engine (not shown). The device processor 186 may be configured to execute various instructions. For example, the device processor 186 may be configured to execute the device instructions 192 to implement functions or perform operations disclosed herein, such as some or all of those described with respect to FIGS. 1-3B. In some embodiments, the functions described herein are implemented using logic units, FPGAs, ASICs, DSPs, or any other suitable hardware or electronic circuitry.

The device databases 188 may be one or more storage devices configured to perform one or more storage operations. The device databases 188 may be configured to perform one or more operations described in reference to the databases 119.

In one or more embodiments, the device memory 190 may be operable to store multiple local operation data and one or more local applications associated with the server 102. The local operation data may be data configured to enable one or more data processing operations such as those described in relation with the server 102. The local operation data may be partially or completely different from those comprised in the server memory 130. The local applications may be one or more of the services described in relation with the server 102. In some embodiments, the local applications may be partially or completely different from those comprised in the server memory 130. Further, the device memory 190 may be operable to store one or more device instructions 192.

### User Device

In one or more embodiments, each of the user devices 106 (e.g., the user devices 106a-106c in the user device group 113) may be any computing device configured to communicate with other devices, such as the server 102, other user devices 106 in the user device group 113, databases, and the like in the system 100. Each of the user devices 106 may be configured to perform specific functions described herein and interact with the server 102 and/or any other user devices 106. Examples of the user devices 106 comprise, but are not limited to, a laptop, a computer, a smartphone, a tablet, a smart device, an IoT device, a simulated reality device, an augmented reality device, or any other suitable type of device. The data exchange operations 179 may be provided by the user devices 106 via one or more interfaces comprising input displays, voice microphones, or sensors capturing gestures performed by a corresponding user 114. In some embodiments, while FIG. 1 shows the user device 106a, the user device 106b, and the user device 106c, a given user device group 113 may comprise less or more user devices 106.

The user devices 106 may be hardware configured to create, transmit, and/or receive information. The user devices 106 may be configured as a provider node or as worker nodes. The user devices 106 may be configured to receive inputs from a user, process the inputs, and generate data information or command information in response. The data information may include documents or files generated using a graphical user interface (GUI).

### Electronic Attacker

In one or more embodiments, electronic attackers 118 may be any electronic device that influences the operations of one or more devices in the network 110. In some embodiments, the electronic attacker group comprises multiple devices configured to interfere with operations of devices in the network 110. Each of the electronic attackers 118 may perform one or more attacks 122. The attacks 122 (e.g., one or more electronic attacks) may be one or more unexpected operations triggered by the electronic attackers 118 in the network 110. In some embodiments, a single electronic attacker 118 may perform one or more attacks 122. In other embodiments, multiple electronic attackers 118 may perform one or more attacks 122.

Referring as a non-limiting example to the electronic attacker 118 of FIG. 1, the electronic attacker 118 may be hardware and/or software, executed by hardware, which launches the attacks 122 to affect the operations performed by the server 102 and/or the user devices 106. Although not explicitly shown in FIG. 1, the electronic attacker 118 may include a processor, a memory, and a transceiver configured to generate one or more communication signals. In one or more embodiments, the electronic attacker 118 is a new device in a predetermined area in which the server 102 and/or the user devices 106 are located. In some embodiments, radio waves, electromagnetic (EM) signaling, and/or data exchange operations 137 from the electronic attacker 118 are monitored over time in the network 110 to be evaluated in combination with one or more aforementioned operations.

In one or more embodiments, the electronic attacker 118 may be a person, people, or an automated electric component that use the attacks 122 to hack communications and operations of a specific user device 106 and/or the server 102. As a result of the attacks 122, the electronic attacker 118 may control communications or operations of one or more of the hacked user devices 106. In this regard, the electronic attacker 118 may modify, cancel, or generate communications or operations in the hacked user devices 106. The electronic attacker 118 may pretend to perform one or more operations on behalf of one or more of the user devices 106.

### Network Graphs

In one or more embodiments, the network graphs 193 comprise peer-to-peer and/or decentralized networking protocols and/or blockchain protocols that enable development of serverless applications. The network graphs 193 may comprise one or more artificial neural networks configured to be regulated, updated, and/or controlled by one or more of the AI algorithms 142. The network graphs 193 may include multiple electronic components or devices (i.e., nodes 194) comprising specific node data. The nodes 194 may not be required to store or validate all data in the network graphs 193. Instead, validation of each node's data may be obtained via peer accountability.

The network graphs 193 may be one or more artificial neural networks configured to act as one or more machine learning programs, or models, configured to make decisions dynamically and progressively increasing complexity of a subject matter. The network graphs 193 may be configured to comprise layers of nodes 194, or artificial neurons. The layers may comprise an input layer, one or more hidden layers, and an output layer. Each of the nodes 194 may be configured to connects to others and may comprise one or more aspects of the rules and policies 162.

In some embodiments, the nodes 194 may include own data and a reference to all other data in the network graphs 193 in accordance with rules and policies 162 preestablished by an electronic component or device outside the network graphs 193 (e.g., one or more servers, such as the server 102). These rules and policies 162 may determine how the nodes 194 interact with each other and the server 102. The rules and policies 162 may be updated dynamically or periodically with additional data received as updates via one or more planning components (e.g., electronic devices or components configured to provide updates to the rules and policies 162). The updates may be triggered by a perceived lack of knowledge level in the nodes 194. A perceived knowledge level in the nodes 194 may be identified via node scores (not shown) received from the server 102 as feedback.

The network graphs 193 may be configured to provide infrastructure associated with maintenance and use of the VAEs, SHAP, and/or the ZTNA. artificial neural networks configured to modify one or more operations and/or perform regression training of one or more models 146 based on positive feedback and/or negative feedback. Under positive feedback, the artificial neural networks may be configured to receive feedback data comprising one or more inputs indicating that the server 102 correctly identified a format anomaly in one of the electronic data streams 136. Under negative feedback, the artificial neural networks may be configured to receive feedback data comprising one or more inputs indicating that the server 102 incorrectly identified a format anomaly in one of the electronic data streams 136.

In one or more embodiments, each node (i.e., out of nodes 194) in the network graphs 193 includes knowledge-specific information and information associated with peer accountability and a perceived knowledge level. Each node 194 may be configured to perform one or more neuro-symbolic processing operations that evaluate an overall format of the information. Specifically, referencing a node 194 as a non-limiting example, includes rules and policies 162 and/or one or more data exchange controls. The data exchange controls may include information corresponding to at least one knowledge domain configured to evaluate aspects of the information. In some embodiments, the nodes 194 may be generated in accordance with one or more user devices 106. The nodes 194 may be communicatively coupled to one another in accordance with one or more relation paths 195 that relate the nodes 194 to one another.

In other embodiments, each of the nodes 194 includes a processor (not shown) configured to provide updates corresponding to specific data exchange controls. The processor in the nodes 194 may be configured to provide updated responses directly to the server processor 126. Further, a processor of the nodes 194 may be configured to determine one or more knowledge aspects as related by one or more relation paths 195. The network graphs 193 may be graph convolutional networks (GCNs), generative adversarial networks (GANs), Multi-Layered Perceptron (MLP), Convolution Neural Network (CNN), and/or one or more neural networks. As described above the artificial neural networks may be trained using positive feedback loops and/or negative feedback loops. The artificial neural networks may be controlled in accordance and/or by one or more machine learning models configured to organize and/or perform operations using the nodes 194 to operate in accordance with one or more of the graph convolutional networks (GCNs), generative adversarial networks (GANs), Multi-Layered Perceptron (MLP), and/or Convolution Neural Network (CNN).

The artificial neural networks may be a Multi-Layered Perceptron (MLP). The artificial neural networks may be a Multi-Layered Perceptron (MLP). In deep learning, the MLP may be a neural network consisting of fully connected neurons with nonlinear activation functions, organized in layers, notable for being able to distinguish data that is not linearly separable. The MLP may comprise fully connected and/or dense layers that transform input data from one dimension to another. The MLP may comprise an input layer, one or more hidden layers, and an output layer. The MLP may be configured to model complex relationships between inputs and outputs. The artificial neural network may be a Convolution Neural Network (CNN). The CNN may be a regularized type of feed-forward neural network that learns features by itself via a filter (or kernel) optimization.

In one or more embodiments, the network graphs 193 comprise one or more VAEs. The VAEs may be configured to used for generating new data samples, especially images, and for tasks like data denoising, anomaly detection, and dimensionality reduction. The VAEs may be configured to learn a distribution of data in a latent space and generate new data points within the learned distribution.

In one or more embodiments, the network graphs 193 may be configured to use Shapley values. Herein, SHAP is a concept from game theory used in machine learning to explain output of models by attributing each input feature's contribution to a final prediction. The Shapley values provide a way to understand how much each feature in a piece of information influences a model's prediction, helping to make complex models more transparent and interpretable.

In one or more embodiments, the network graphs 193 may be configured to implement a ZTNA protocol. Herein, the ZTNA protocol provides secure and granular access to applications and resources for distributed devices (e.g., not necessarily collocated in a same space), by verifying a device identifier, device signature (e.g., current performance evaluated against a performance baseline), and network context. The ZTNA protocol shifts from trusting all traffic within a network to verifying each access request, reducing a possible attack surface and improving security.

### Example Process to Dynamically Route Communications Using Weighted Prioritization Tags

In one or more embodiments, the server 102 is configured to perform SHAP powered sentiment analysis and interpretation system with VAEs within a ZTNA environment to provide advanced, dynamic, interpretable insights into customer interactions. The server 102 may be configured to leverage the strengths of SHAP to explain output data and VAEs for efficient data representation, ensuring both transparency and accuracy in sentiment analysis and interpretation. The server 102 may be configured to utilize the VAEs to learn latent representations of operations and/or interactions performed by specific user devices 106 and SHAP-based explainable AI techniques to interpret these representations and generate actionable insights 156.

### Example Process to Dynamically Route Communications Using Weighted Prioritization Tags

FIG. 2 illustrates an example flowchart of a process 200 configured to dynamically route communications using weighted prioritization tags 152. Modifications, additions, or omissions may be made to the process 200. The process 200 may comprise more, fewer, or other operations than those shown in FIG. 2. For example, operations may be performed in parallel or in any suitable order. While at times discussed as the server 102, the workspace devices 105, the user devices 106, or components of any of thereof performing operations described in operations 202-232 in the process 200, any suitable system or components of the system 100 may perform one or more operations of the process 200. For example, one or more operations of the process 200 may be implemented, at least in part, in the form of instructions 132 of FIG. 1, stored on non-transitory, tangible, machine-readable media (e.g., the server memory 130 operating as a non-transitory computer-readable medium of FIG. 1) that when run by one or more processors (e.g., the server processor 126 of FIG. 1) may cause the one or more processors to perform operations described in operations 202-232.

In FIG. 2, the process 200 starts at operation 202, where the server 102 is configured to intercept a data stream 136 exchanged between a user device 106a (e.g., representative of any user devices 106) and a workspace device 105a (e.g., representative of any workspace devices 105). The server 102 may be configured to detect an attempt to exchange an electronic data stream 136 between a transmitting device and a receiving device (e.g., the user device 106a and the workspace device 105a). In some embodiments, the server 102 may be configured to receive the electronic data stream 136 and/or a specific piece of data, data record, and/or data element transmitted to the receiving device. The data stream 136 may comprise a communication packet 138 as part of a current data exchange operation 179. At operation 204, the server 102 is configured to electronically extract a current topic 173 associated with the current data exchange operation 179. At operation 206, the server 102 is configured to train, during a first phase (e.g., at a first training stage 170), an AI algorithm 142 using first input data 148 comprising historical data 150 of previous data exchange operations 179 associated with user device 106a, previous topics 172, and weighted prioritization tags 152.

At operation 210, the server 102 is configured to determine, using the trained AI algorithm 142, whether the current topic 173 extracted from the data exchange operation 179 matches one of the previous topics 172. If the server 102 determines that a current topic 173 does not match one of the previous topics 172 (e.g., NO), the process 200 proceeds to operation 212. At operation 212, where the server 102 is configured to, using the trained AI algorithm 142, generate a weighted prioritization tag 152 corresponding to the current topic 173 based at least in part upon a level of difficulty associated with the current topic 173. The level of difficulty may be determined using a knowledge pool available to the server 102. If the knowledge pool comprises several workspace devices 105 and/or nodes 194 configured to handle a specific knowledge area, the level of difficulty is ranked lower. If the knowledge pool comprises a small number (e.g., less than five percent out of a total) of workspace devices 105 and/or nodes 194 configured to handle a specific knowledge area, the level of difficulty is ranked higher. At operation 214, where the server 102 is configured to, using the trained AI algorithm 142, assign the weighted prioritization tag 152 to the current topic 173. At operation 216, where the server 102 is configured to, using the trained AI algorithm 142, electronically extract an insight 156 from the current data exchange operation 179. If the server 102 determines that a current topic matches one of the previous topics (e.g., YES), the process 300 proceeds to operation 222.

At operation 222, the server 102 is configured to assign a weighted prioritization tag 152 associated with the matched previous topic 172 to the current topic 173. In response to determining that the current topic 173 matches one of the previous topics 172, assigning a weighted prioritization tag 152 associated with the previous topic 172 to the current topic173. At operation 224, the server 102 is configured to, using the trained AI algorithm 142, electronically extract an insight 156 from current data exchange operation 179. At operation 226, the server 102 is configured to modify a value (e.g., create a modified prioritization value 175) of the weighted prioritization tag 152 assigned to the current topic 173 based at least in part upon the insight 156. At operation 228, the server 102 is configured to generate, using the trained AI algorithm 142, an explanation file 176 reporting an insight type 158 associated with the insight 156 and an impact 160 of the insight type 158 in value of the weighted prioritization tag 152. At operation 230, the server 102 is configured to, using the trained AI algorithm 142, queue the communication packet 138 for interaction with the workspace device 105a at a queue position 174. The queue position 174 is based at least in part upon a modified value of the weighted prioritization tag 152 and, after receiving the communication packet 138, the workspace device 105a is configured to perform sub-operations 161 triggered by the current data exchange operation 179.

The process 200 may end at operation 232, where the server 102 is configured to train, during a second phase, the AI algorithm 142 using second input data 148 comprising the historical data 150 of the previous data exchange operations 179 associated with the user device 106a, the current data exchange operation 179, the previous topics 172, the weighted prioritization tags 152, and the explanation file 176.

In some embodiments, the explanation file 176 comprises one or more local explanation commands 177 that are specific to the user device 106a. The local explanation commands 177 may comprise guidance to respond to the current data exchange operation 179. The explanation file 176 may comprise global explanation commands 177 corresponding to the insight type 158. The global explanation commands 177 may comprise guidance to respond to future data exchange operations 179 comprising a same insight type 158. In some embodiments, the server 102 may be configured to, in conjunction with electronically extracting the current topic 173 associated with the current data exchange operation 179, electronically isolate a first content type 178 and a second content type 178 in the current data exchange operation 179. For example, the first content type 178 may comprise first text words and the second content type 178 may comprise second text words. The server 102 may be configured to verify that the first content type 178 is a common content type, verify that the second content type 178 is a unique content type, discard the first text words associated with the first content type 178, and maintain the second text words associated with the second content type 178. The current topic may be electronically extracted from the second text words in the current data exchange operation 179. Herein, the server 102 may be configured to filter common information and/or unique information from the data exchange operations 179.

### Scope of the Disclosure

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory operable to store:
a plurality of previous topics previously determined to be comprised in previous data exchange operations performed by a user device; and
a plurality of weighted prioritization tags used to prioritize one or more of the previous data exchange operations performed by the user device; and
at least one processor communicatively coupled to the memory and configured to:
intercept a data stream exchanged between the user device and a workspace device, the data stream comprising a communication packet as part of a current data exchange operation;
electronically extract a current topic associated with the current data exchange operation;
train, during a first phase, an artificial intelligence algorithm using first input data comprising historical data of the previous data exchange operations associated with the user device, the plurality of previous topics, and the plurality of weighted prioritization tags;
determine, using the artificial intelligence algorithm, whether the current topic matches a previous topic in the plurality of previous topics;
in response to determining that the current topic matches the previous topic in the plurality of previous topics, assign a weighted prioritization tag associated with the previous topic to the current topic;
electronically extract, using the artificial intelligence algorithm, an insight from the current data exchange operation;
modify, using the artificial intelligence algorithm, a value of the weighted prioritization tag assigned to the current topic based at least in part upon the insight;
generate, using the artificial intelligence algorithm, an explanation file reporting an insight type associated with the insight and an impact of the insight type in the value of the weighted prioritization tag;
queue, using the artificial intelligence algorithm, the communication packet for interaction with the workspace device at a queue position, wherein:
the queue position is based at least in part upon a modified value of the weighted prioritization tag; and
after receiving the communication packet, the workspace device is configured to perform a plurality of sub-operations triggered by the current data exchange operation; and
train, during a second phase, the artificial intelligence algorithm using second input data comprising the historical data of the previous data exchange operations associated with the user device, the current data exchange operation, the plurality of previous topics, the plurality of weighted prioritization tags, and the explanation file.

2. The system of claim 1, wherein:
the explanation file comprises a plurality of local explanation commands that are specific to the user device; and
the plurality of local explanation commands comprises guidance to respond to the current data exchange operation.

3. The system of claim 1, wherein:
the explanation file comprises a plurality of global explanation commands corresponding to the insight type; and
the plurality of global explanation commands comprises guidance to respond to future data exchange operations comprising a same insight type.

4. The system of claim 1, wherein the at least one processor is further configured to:
in conjunction with electronically extracting the current topic associated with the current data exchange operation, electronically isolate a first content type and a second content type in the current data exchange operation, wherein:
the first content type comprises a first plurality of text words; and
the second content type comprises a second plurality of text words;
verify that the first content type is a common content type;
verify that the second content type is a unique content type;
discard the first plurality of text words associated with the first content type; and
maintain the second plurality of text words associated with the second content type, wherein the current topic is electronically extracted from the second plurality of text words in the current data exchange operation.

5. The system of claim 1, wherein the at least one processor is further configured to:
intercept an additional data stream exchanged between the user device and the workspace device, the additional data stream comprising an additional communication packet as part of an additional current data exchange operation;
electronically extract an additional current topic associated with the additional current data exchange operation;
determine, using the artificial intelligence algorithm, whether the additional current topic matches an additional previous topic in the plurality of previous topics;
in response to determining that the additional current topic does not match the additional previous topic in the plurality of previous topics, generate an additional weighted prioritization tag corresponding to the additional current topic;
assign the additional weighted prioritization tag to the additional current topic;
electronically extract, using the artificial intelligence algorithm, an additional insight from the additional current data exchange operation;
generate, using the artificial intelligence algorithm, an additional explanation file reporting an additional insight type associated with the additional insight; and
queue, using the artificial intelligence algorithm, the additional communication packet for interaction with the workspace device at an additional queue position, wherein:
the additional queue position is based at least in part upon an additional modified value of the additional weighted prioritization tag; and
after receiving the additional communication packet, the workspace device is configured to perform an additional plurality of sub-operations triggered by the additional current data exchange operation.

6. The system of claim 1, wherein the at least one processor is further configured to:
intercept an additional data stream exchanged between the user device and the workspace device, the additional data stream comprising an additional communication packet as part of an additional current data exchange operation;
electronically extract an additional current topic associated with the additional current data exchange operation;
determine, using the artificial intelligence algorithm, whether the additional current topic matches an additional previous topic in the plurality of previous topics;
in response to determining that the additional current topic matches the additional previous topic in the plurality of previous topics, assign an additional weighted prioritization tag associated with the additional previous topic to the additional current topic;
electronically extract, using the artificial intelligence algorithm, an additional insight from the additional current data exchange operation;
modify, using the artificial intelligence algorithm, an additional value of the additional weighted prioritization tag assigned to the additional current topic based at least in part upon the additional insight;
generate, using the artificial intelligence algorithm, an additional explanation file reporting an additional insight type associated with the additional insight and an additional impact of the additional insight type in the additional value of the additional weighted prioritization tag; and
queue, using the artificial intelligence algorithm, the additional communication packet for interaction with the workspace device at an additional queue position, wherein:
the additional queue position is based at least in part upon an additional modified value of the additional weighted prioritization tag; and
after receiving the additional communication packet, the workspace device is configured to perform an additional plurality of sub-operations triggered by the additional current data exchange operation.

7. The system of claim 1, wherein the at least one processor is further configured to:
intercept a first additional data stream exchanged between the user device and the workspace device, the first additional data stream comprising a first additional communication packet as part of a first additional current data exchange operation;
electronically extract a first additional current topic associated with the first additional current data exchange operation;
generate, using the artificial intelligence algorithm, a first additional weighted prioritization tag associated with the first additional current topic;
electronically extract, using the artificial intelligence algorithm, a first additional insight from the first additional current data exchange operation;
assign the first additional weighted prioritization tag to the first additional current topic based at least in part upon the first additional insight;
queue, using the artificial intelligence algorithm, the first additional communication packet for interaction with the workspace device at a first additional queue position;
intercept a second additional data stream exchanged between an additional user device and the workspace device, the second additional data stream comprising a second additional communication packet as part of a second additional current data exchange operation;
electronically extract a second additional current topic associated with the second additional current data exchange operation;
generate, using the artificial intelligence algorithm, a second additional weighted prioritization tag associated with the second additional current topic;
electronically extract, using the artificial intelligence algorithm, a second additional insight from the second additional current data exchange operation;
assign the second additional weighted prioritization tag to the second additional current topic based at least in part upon the second additional insight; and
queue, using the artificial intelligence algorithm, the second additional communication packet for interaction with the workspace device at a second additional queue position, wherein:
the first additional queue position is before the second additional queue position.

8. A method, comprising:
intercepting a data stream exchanged between a user device and a workspace device, the data stream comprising a communication packet as part of a current data exchange operation;
electronically extracting a current topic associated with the current data exchange operation;
training, during a first phase, an artificial intelligence algorithm using first input data comprising historical data of previous data exchange operations associated with the user device, a plurality of previous topics, and a plurality of weighted prioritization tags;
determining, using the artificial intelligence algorithm, whether the current topic matches a previous topic in the plurality of previous topics;
in response to determining that the current topic matches the previous topic in the plurality of previous topics, assigning a weighted prioritization tag associated with the previous topic to the current topic;
electronically extracting, using the artificial intelligence algorithm, an insight from the current data exchange operation;
modifying, using the artificial intelligence algorithm, a value of the weighted prioritization tag assigned to the current topic based at least in part upon the insight;
generating, using the artificial intelligence algorithm, an explanation file reporting an insight type associated with the insight and an impact of the insight type in the value of the weighted prioritization tag;
queuing, using the artificial intelligence algorithm, the communication packet for interaction with the workspace device at a queue position, wherein:
the queue position is based at least in part upon a modified value of the weighted prioritization tag; and
after receiving the communication packet, the workspace device is configured to perform a plurality of sub-operations triggered by the current data exchange operation; and
training, during a second phase, the artificial intelligence algorithm using second input data comprising the historical data of the previous data exchange operations associated with the user device, the current data exchange operation, the plurality of previous topics, the plurality of weighted prioritization tags, and the explanation file.

9. The method of claim 8, wherein:
the explanation file comprises a plurality of local explanation commands that are specific to the user device; and
the plurality of local explanation commands comprises guidance to respond to the current data exchange operation.

10. The method of claim 8, wherein:
the explanation file comprises a plurality of global explanation commands corresponding to the insight type; and
the plurality of global explanation commands comprises guidance to respond to future data exchange operations comprising a same insight type.

11. The method of claim 8, further comprising:
in conjunction with electronically extracting the current topic associated with the current data exchange operation, electronically isolating a first content type and a second content type in the current data exchange operation, wherein:
the first content type comprises a first plurality of text words; and
the second content type comprises a second plurality of text words;
verifying that the first content type is a common content type;
verifying that the second content type is a unique content type;
discarding the first plurality of text words associated with the first content type; and
maintaining the second plurality of text words associated with the second content type, wherein the current topic is electronically extracted from the second plurality of text words in the current data exchange operation.

12. The method of claim 8, further comprising:
intercepting an additional data stream exchanged between the user device and the workspace device, the additional data stream comprising an additional communication packet as part of an additional current data exchange operation;
electronically extracting an additional current topic associated with the additional current data exchange operation;
determining, using the artificial intelligence algorithm, whether the additional current topic matches an additional previous topic in the plurality of previous topics;
in response to determining that the additional current topic does not match the additional previous topic in the plurality of previous topics, generating an additional weighted prioritization tag corresponding to the additional current topic;
assigning the additional weighted prioritization tag to the additional current topic;
electronically extracting, using the artificial intelligence algorithm, an additional insight from the additional current data exchange operation;
generating, using the artificial intelligence algorithm, an additional explanation file reporting an additional insight type associated with the additional insight; and
queuing, using the artificial intelligence algorithm, the additional communication packet for interaction with the workspace device at an additional queue position, wherein:
the additional queue position is based at least in part upon an additional modified value of the additional weighted prioritization tag; and
after receiving the additional communication packet, the workspace device is configured to perform an additional plurality of sub-operations triggered by the additional current data exchange operation.

13. The method of claim 8, further comprising:
intercepting an additional data stream exchanged between the user device and the workspace device, the additional data stream comprising an additional communication packet as part of an additional current data exchange operation;
electronically extracting an additional current topic associated with the additional current data exchange operation;
determining, using the artificial intelligence algorithm, whether the additional current topic matches an additional previous topic in the plurality of previous topics;
in response to determining that the additional current topic matches the additional previous topic in the plurality of previous topics, assigning an additional weighted prioritization tag associated with the additional previous topic to the additional current topic;
electronically extracting, using the artificial intelligence algorithm, an additional insight from the additional current data exchange operation;
modifying, using the artificial intelligence algorithm, an additional value of the additional weighted prioritization tag assigned to the additional current topic based at least in part upon the additional insight;
generating, using the artificial intelligence algorithm, an additional explanation file reporting an additional insight type associated with the additional insight and an additional impact of the additional insight type in the additional value of the additional weighted prioritization tag; and
queuing, using the artificial intelligence algorithm, the additional communication packet for interaction with the workspace device at an additional queue position, wherein:
the additional queue position is based at least in part upon an additional modified value of the additional weighted prioritization tag; and
after receiving the additional communication packet, the workspace device is configured to perform an additional plurality of sub-operations triggered by the additional current data exchange operation.

14. The method of claim 8, further comprising:
intercepting a first additional data stream exchanged between the user device and the workspace device, the first additional data stream comprising a first additional communication packet as part of a first additional current data exchange operation;
electronically extracting a first additional current topic associated with the first additional current data exchange operation;
generating, using the artificial intelligence algorithm, a first additional weighted prioritization tag associated with the first additional current topic;
electronically extracting, using the artificial intelligence algorithm, a first additional insight from the first additional current data exchange operation;
assigning the first additional weighted prioritization tag to the first additional current topic based at least in part upon the first additional insight;
queuing, using the artificial intelligence algorithm, the first additional communication packet for interaction with the workspace device at a first additional queue position;
intercepting a second additional data stream exchanged between an additional user device and the workspace device, the second additional data stream comprising a second additional communication packet as part of a second additional current data exchange operation;
electronically extracting a second additional current topic associated with the second additional current data exchange operation;
generating, using the artificial intelligence algorithm, a second additional weighted prioritization tag associated with the second additional current topic;
electronically extracting, using the artificial intelligence algorithm, a second additional insight from the second additional current data exchange operation;
assigning the second additional weighted prioritization tag to the second additional current topic based at least in part upon the second additional insight; and
queuing, using the artificial intelligence algorithm, the second additional communication packet for interaction with the workspace device at a second additional queue position, wherein:
the first additional queue position is before the second additional queue position.

15. A non-transitory computer-readable medium storing instructions that when executed by a processor cause the processor to:
intercept a data stream exchanged between a user device and a workspace device, the data stream comprising a communication packet as part of a current data exchange operation;
electronically extract a current topic associated with the current data exchange operation;
train, during a first phase, an artificial intelligence algorithm using first input data comprising historical data of previous data exchange operations associated with the user device, a plurality of previous topics, and a plurality of weighted prioritization tags;
determine, using the artificial intelligence algorithm, whether the current topic matches a previous topic in the plurality of previous topics;
in response to determining that the current topic matches the previous topic in the plurality of previous topics, assign a weighted prioritization tag associated with the previous topic to the current topic;
electronically extract, using the artificial intelligence algorithm, an insight from the current data exchange operation;
modify, using the artificial intelligence algorithm, a value of the weighted prioritization tag assigned to the current topic based at least in part upon the insight;
generate, using the artificial intelligence algorithm, an explanation file reporting an insight type associated with the insight and an impact of the insight type in the value of the weighted prioritization tag;
queue, using the artificial intelligence algorithm, the communication packet for interaction with the workspace device at a queue position, wherein:
the queue position is based at least in part upon a modified value of the weighted prioritization tag; and
after receiving the communication packet, the workspace device is configured to perform a plurality of sub-operations triggered by the current data exchange operation; and
train, during a second phase, the artificial intelligence algorithm using second input data comprising the historical data of the previous data exchange operations associated with the user device, the current data exchange operation, the plurality of previous topics, the plurality of weighted prioritization tags, and the explanation file.

16. The non-transitory computer-readable medium of claim 15, wherein:
the explanation file comprises a plurality of local explanation commands that are specific to the user device; and
the plurality of local explanation commands comprises guidance to respond to the current data exchange operation.

17. The non-transitory computer-readable medium of claim 15, wherein:
the explanation file comprises a plurality of global explanation commands corresponding to the insight type; and
the plurality of global explanation commands comprises guidance to respond to future data exchange operations comprising a same insight type.

18. The non-transitory computer-readable medium of claim 15, wherein, when executed by the processor, the instructions further cause the processor to:
in conjunction with electronically extracting the current topic associated with the current data exchange operation, electronically isolate a first content type and a second content type in the current data exchange operation, wherein:
the first content type comprises a first plurality of text words; and
the second content type comprises a second plurality of text words;
verify that the first content type is a common content type;
verify that the second content type is a unique content type;
discard the first plurality of text words associated with the first content type; and
maintain the second plurality of text words associated with the second content type, wherein the current topic is electronically extracted from the second plurality of text words in the current data exchange operation.

19. The non-transitory computer-readable medium of claim 15, wherein, when executed by the processor, the instructions further cause the processor to:
intercept an additional data stream exchanged between the user device and the workspace device, the additional data stream comprising an additional communication packet as part of an additional current data exchange operation;
electronically extract an additional current topic associated with the additional current data exchange operation;
determine, using the artificial intelligence algorithm, whether the additional current topic matches an additional previous topic in the plurality of previous topics;
in response to determining that the additional current topic does not match the additional previous topic in the plurality of previous topics, generate an additional weighted prioritization tag corresponding to the additional current topic;
assign the additional weighted prioritization tag to the additional current topic;
electronically extract, using the artificial intelligence algorithm, an additional insight from the additional current data exchange operation;
generate, using the artificial intelligence algorithm, an additional explanation file reporting an additional insight type associated with the additional insight; and
queue, using the artificial intelligence algorithm, the additional communication packet for interaction with the workspace device at an additional queue position, wherein:
the additional queue position is based at least in part upon an additional modified value of the additional weighted prioritization tag; and
after receiving the additional communication packet, the workspace device is configured to perform an additional plurality of sub-operations triggered by the additional current data exchange operation.

20. The non-transitory computer-readable medium of claim 15, wherein:
intercept an additional data stream exchanged between the user device and the workspace device, the additional data stream comprising an additional communication packet as part of an additional current data exchange operation;
electronically extract an additional current topic associated with the additional current data exchange operation;
determine, using the artificial intelligence algorithm, whether the additional current topic matches an additional previous topic in the plurality of previous topics;
in response to determining that the additional current topic matches the additional previous topic in the plurality of previous topics, assign an additional weighted prioritization tag associated with the additional previous topic to the additional current topic;
electronically extract, using the artificial intelligence algorithm, an additional insight from the additional current data exchange operation;
modify, using the artificial intelligence algorithm, an additional value of the additional weighted prioritization tag assigned to the additional current topic based at least in part upon the additional insight;
generate, using the artificial intelligence algorithm, an additional explanation file reporting an additional insight type associated with the additional insight and an additional impact of the additional insight type in the additional value of the additional weighted prioritization tag; and
queue, using the artificial intelligence algorithm, the additional communication packet for interaction with the workspace device at an additional queue position, wherein:
the additional queue position is based at least in part upon an additional modified value of the additional weighted prioritization tag; and
after receiving the additional communication packet, the workspace device is configured to perform an additional plurality of sub-operations triggered by the additional current data exchange operation.
